(19) United States
(12) Patent Application Publication
(10) Pub. No.: US 2007/0274304 A1
(43) Pub. Date: Nov. 29, 2007

(54) Fail rate method for fast measurement of equipment reliabiliy

(76) Inventor: William H. Lycette, Santa Rosa, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/439,053

(22) Filed: May 23, 2006

(51) Int. Cl. H04L 12/50

(52) U.S. Cl. 370/370

(57) ABSTRACT

In an embodiment of an Fast Fail Rate method, a failure rate is determined for a population of pieces of equipment in use over a period of time. The method comprises selecting a period of time, segmenting the period of time into multiple time intervals; obtaining data for the population of pieces of equipment, the data broken down over the time intervals; and computing a life data distribution for the data, the life data distribution being associated with a given time, and being based on the obtained data for time intervals prior to the given point in time.

### BACKGROUND OF THE INVENTION

A widely used method for measuring reliability of equipment, in use by customers or other users, is through the calculation of field failure rates using non-parametric methods known variously as the Annualized Failure Rate or the like (hereinafter “AFR”). Such methods are described in “AFR: Problems of Definition, Calculation and Measurement in a Commercial Environment” by Jon G. Elerath.

Such conventional methods generally rely upon simple calculations involving the number of failures and the size of the population of pieces of equipment in use. The computation is quick and straightforward, can be performed by someone who is not familiar with reliability statistics, and can be easily explained to the layperson. No special software or graphing paper is required to make the calculation. For these reasons, non-parametric methods such as AFR are widely used in industry to measure the reliability of electronic equipment.

However, AFR methods tend to respond slowly to changes in product reliability (both degradation and improvement) during a product's manufacturing life cycle. While customers quickly perceive degradation in quality and reliability, it may take several months before such degradation appears in an AFR scheme.

Also, many of such metrics are predicated on the potentially false assumption that the underlying failure rate is constant over time. These methods also do not allow for conditional probability calculations, or for quantification of confidence bounds.

### SUMMARY OF THE INVENTION

In an embodiment of a fast fail rate (hereinafter referred to as “FFR”) method of the invention, a failure rate is determined for a population of pieces of equipment in use over a period of time. The method comprises selecting a period of time, segmenting the period of time into multiple time intervals; obtaining data for the population of pieces of equipment, the data broken down over the time intervals; and computing a life data distribution for the data, the life data distribution being associated with a given time, and being based on the obtained data for time intervals prior to the given point in time.

Further features and advantages of the present invention, as well as the structure and operation of preferred embodiments of the present invention, are described in detail below with reference to the accompanying exemplary drawings.

### BRIEF DESCRIPTION OF THE DRAWINGS

FIG. 1 is a flowchart showing an embodiment of the invention.

FIG. 2 is a timing diagram illustrating an aspect of an embodiment of the invention.

FIG. 3 is a flowchart showing further details of an embodiment of the invention.

### DETAILED DESCRIPTION

Complex electronic equipment, such as test and measurement equipment, is characterized by having between a few thousand electronic components and more than 10,000 electronic components, while at the same time having relatively few mechanical components. With the advancement in design and manufacturing technology over the past 10-20 years, such equipment has typically exhibited constant or improving electronic component failure rates over the early- to mid-part of its operating life (so-called “infant mortality”). Eventually the equipment enters a wear-out phase, which is marked by a rapidly increasing fail rate. However, for electronic components the wear-out phase is generally well beyond the normal expected operating life of the equipment. Therefore owners of such equipment will rarely experience such wear-out electronic component failures.

Mechanical parts are susceptible to wear-out failure mechanisms. However, their relatively low numbers in electronic measurement equipment and recent advances in their reliability have resulted in products where customer-experienced failure of mechanical parts is fairly small over the expected operating life.

While the invention applies to a wide variety of types of equipment, etc., the discussion which follows will focus, for exemplary purposes, on the invention's applicability to such complex electronic equipment.

Waiting six, nine or even 12 months for a reliability problem to be reflected in traditional non-parametric metrics represents a huge delay in solving the root cause of the problem. In the mean time, shipments of units of equipment that exhibit the problem continue, thus increasing the installed base (hereinafter “equipment population” or “population”) and associated exposure to higher warranty costs, greater customer dissatisfaction and lost future sales. Additionally, it can be frustrating and costly to wait long periods of time to determine whether or not a recently-implemented fix was actually successful. Metrics such as AFR are slow to reflect the effectiveness of such a fix, and several months of patiently monitoring the AFR may give way to making costly, unnecessary investments in additional reliability improvements.

The Fast Fail Rate method helps mitigate these problems by providing quicker notification to manufacturers that 1) a new problem exists, or 2) an implemented solution was effective.

AFR methods do not allow for quantification of confidence bounds The term “confidence bound” refers, with reference to two predetermined failure rate numbers, to a measure of probability that an observed failure rate will fall between the two predetermined failure rate numbers. Many of such metrics are predicated on the potentially false assumption that the underlying failure rate is constant over time. These methods also do not allow for conditional probability calculations. Another disadvantage of non-parametric methods such as AFR is that they are sluggish to respond to changes in customer-experienced product reliability (both degradation and improvement) during the manufacturing life cycle.

For instance, a Customer-Centric Annualized Fail Rate (CC AFR) has conventionally been used for reporting product reliability. However, as noted above, the CC AFR metric has been sluggish to respond to changes in reliability. When investments to improve reliability culminate in the implementation of a change, it can take as much as 9-12 months before the improvement is observed in the CC AFR.

“Fast Failure Rate” (FFR) embodiments of the invention include a parametric-based measure, and selection of an optimum shipment evaluation window, which provide quicker feedback of changes in a product's reliability. Parametric methods are termed as such because they utilize life data distributions (such as Weibull, Normal and Lognormal) that are mathematically expressed using calculated parameters. Non-parametric methods do not use such life data distributions, and therefore tend to involve relatively simple calculations. The trade off is less accuracy and potentially false assumptions with the simpler, non-parametric method.

Changes in equipment reliability as measured by FFR can be detected by as many as four to six months earlier than would be otherwise possible using some conventional AFR methods. An FFR method therefore is responsive to changes in product reliability (both degradation and improvement) during the manufacturing life cycle.

An FFR method also allows for quantification of confidence bounds, and for conditional probability calculations. It does not require or depend on the assumption that the underlying failure rate is constant over time.

The methodology involves collecting data about the equipment population, such as shipment data (e.g., the date the equipment is shipped to a customer) and Service Order data for warranty failures reported by the customer/user. Such data can be obtained from warranty and shipment databases.

This information is imported into a reliability modeling application. The application fits the information to a life data distribution, such as the exponential, Weibull or lognormal distribution. Once a reliability model is constructed, it then becomes possible to calculate the expected reliability at any point in the product's life. Additionally, confidence bounds can be calculated to quantify the uncertainty of the product's failure rate. By striking a balance between various selected FFR variables so as to yield the best possible combination of quick reliability feedback, effective AFR predictive power and narrow confidence bounds may be obtained.

An FFR method is based on parametric techniques involving reliability statistics and principles. Reliability statistics are described in textbooks and the literature. See, for instance, the following references on reliability processes and statistical methods, that will provide a foundation of principles for aiding in the understanding embodiments of the present invention:
Applied Reliability, Second Edition, Paul A. Tobias and David C. Trindade, CRC Press, 1995.
Practical Reliability Engineering, Fourth Edition, Patrick D. T. O'Connor, John Wiley & Sons, Inc., 2002.
“Practical Considerations in Calculating Reliability of Fielded Products”, Bill Lycette, The Journal of the RAC, Second Quarter 2005, pp. 1-6.

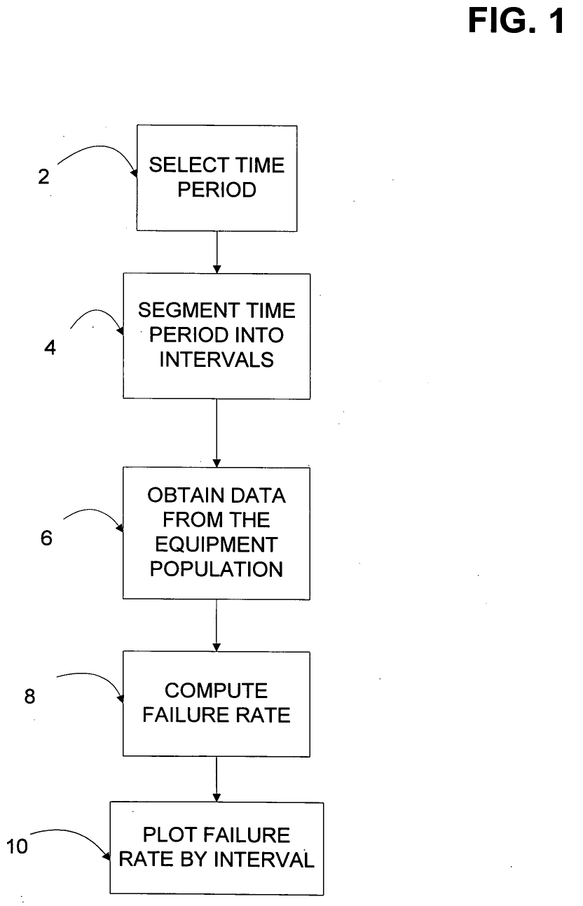

FIG. 1 is a flowchart, showing an embodiment of the invention. The embodiment will operate, to start with a body of data related to a population of pieces of equipment, for instance in use by a population of users such as customers of equipment vendors.

The data includes information on the pieces of equipment making up the population, and particularly includes data regarding (i) incidents, such as equipment failures with fail age, occurring in the course of the use of the equipment, and shipment date, which will enable the survival time between the shipment and the failure to be calculated. The data regarding a given incident will typically include (i) a unique identity for the piece of equipment, such as serial number, registered owner, geographical location, etc., (ii) whether or not an incident, such as a failure, has occurred on the piece of equipment, (iii) the nature of the failure or other incident, and (iv) the date on which the failure occurred or was reported.

The body of data is characterized as covering a period of time. The period of time may, for instance, be thought of as a “Shipment Evaluation Window” if the population of equipment to be studied is equipment sold and shipped to purchasers/users over a period of time during the product's life cycle. The term “Product Life Cycle” refers to the period of time spanning first customer shipment to final customer shipment; this includes products that have undergone design and process changes during this period. The data is obtained gradually over the period of time, and more data continuously comes in.

In a block 2 of the flowchart of FIG. 1, a time period, i.e., a shipment evaluation window, is selected for analysis. The length of the time period may be selected by the user. For instance, one possible shipment evaluation window begins at the time of first product shipment, and runs up to the present. It will often be the case that the method of an embodiment of the invention will be practiced multiple times over time periods running from product introduction up through the most recent data reporting period.

However, there are various criteria which may be taken into consideration in selecting the product evaluation window.

In one embodiment, a shipment evaluation window is selected to strike a balance between the following criteria:
providing timely feedback of reliability changes,
sensitivity to reliability changes during a product's manufacturing life cycle
detecting the occurrence of new failure mechanisms,
providing acceptable confidence bounds,
minimizing reliability false alarms, and
providing useful predictive power for anticipating eventual changes in failure rate.

A short shipment window for study, e.g. one month, will give a failure rate that would be extremely responsive to reliability changes. However, such a short window would also yield unacceptably wide confidence bounds. Additionally, the metric would be a poor predictor of future failures, because most failure modes would not have had a chance to manifest themselves.

At the other extreme, a long shipment analysis window, such as 12 months, would provide tight confidence bounds and a very good predictor of future reliability, however it would be nearly as sluggish to respond as does the CC AFR.

Shipment and failure data, associated with more than a dozen different product families involving complex microwave/RF measurement equipment, has been studied. Experimentation has shown that a good balance between reasonable confidence bounds and a responsive metric can be achieved with a shipment analysis window selected from the range of four to six months. Complex electronic equipment failure mechanisms generally manifest themselves, if at all, within data analysis shipment windows thus chosen.

It has been possible to predict changes in reliability by as many as six months earlier than when a conventional AFR metric would show the change. While not a perfect predictor of future reliability, it has been effective in approximately 70-80% of the product families for which the FFR method has been applied.

A block 4 of the flowchart of FIG. 1 illustrates segmenting the data into time intervals. Often, it will be convenient to use monthly intervals, since much data regarding product shipments, performance, etc., is accumulated and compiled on a monthly basis.

Finally, it will often be the case that the method of the invention will be practiced at successive points in time, such as once every month, so that on each successive month, a new monthly batch of data, covering both equipment shipped that month and incidents relating to equipment previously shipped, will be taken into account. Where the method is practiced successive times in this fashion, a history can be accumulated, trends can be identified, and predictions concerning future failure rates can be made.

Therefore, to illustrate one embodiment of the invention, the Shipment Evaluation Window is designated as the period of time made up of the number of consecutive months containing product shipments, that a reliability analyst wishes to consider in the failure rate prediction. The FFR Reporting Month is defined to be the final month of the Shipment Evaluation Window. Data processing and metric calculation begins one month after the end of the Shipment Evaluation Window. This is designated as the Calculation Date.

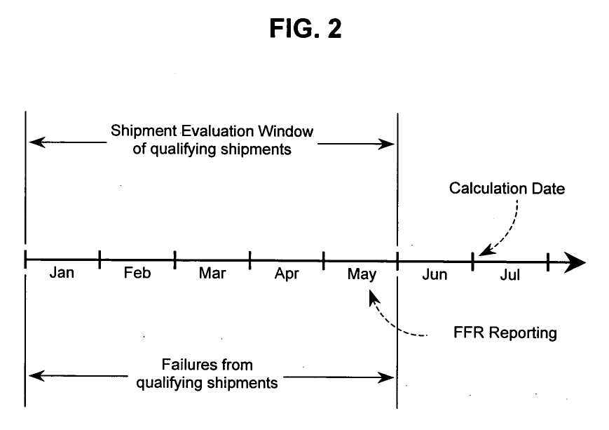

In one embodiment, the period of time (shown in FIG. 2, for instance, as five months) is a sliding window, which advances in time incrementally for each successive calculation. For example, if the shipment evaluation window is five months and a calculation is done on as Calculation Date of July 1 for the months of January through a Reporting Month of May, then the next calculation, in August, may cover the five-month shipment evaluation window, incrementally shifted forward by a month, to run from February through June.

Here is an example of the Fast fail rate Calculation Events for a May Fast Fail Rate Reporting Month as illustrated in the timeline of FIG. 2:
Fast Fail Rate Reporting Month: May
Calculation Date July 1
Shipment Data Window: January 1 through May 31
Qualifying failures: Failures reported through June 30 on products shipped between January 1 through May 31.

Referring again to the flowchart of FIG. 1, a block 6 illustrates obtaining data for the equipment population. For instance, on the Calculation Date, shipment records from the specified Shipment Evaluation Window are collected. This includes collecting failure records from the shipments records. For instance, the failure record may include a “failure age”, i.e., the date on which the failure occurred or the time elapsed since then. The record may also include the nature of the failure or other incident.

The data may be stored in a database as it is accumulated, or otherwise preserved, cataloged, classified, etc., in any manner suitable for making the data available for purposes of use by embodiments of the invention.

A block 8 of the flowchart of FIG. 1 is the computation of a failure rate, such as the FFR for a given reporting month, for the data obtained in the block 6. In one embodiment, the FFR is in the form of a life data distribution for the data obtained in the block 6.

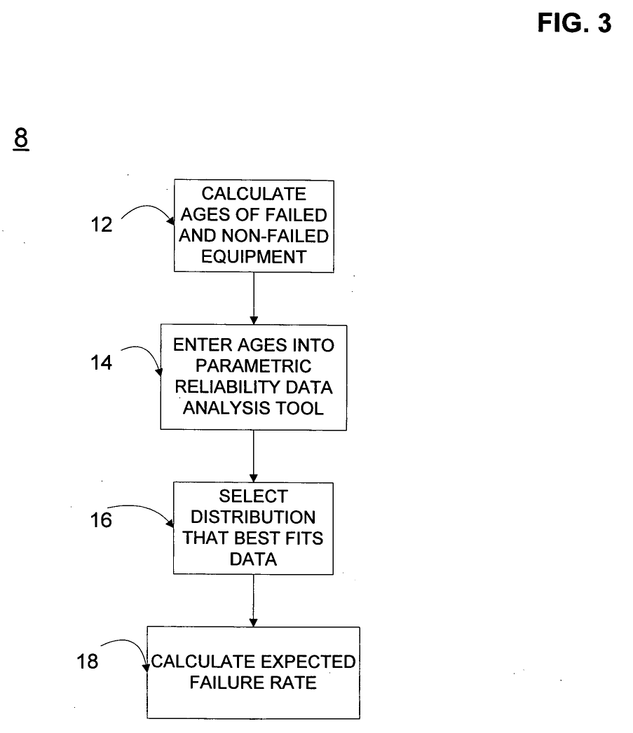

FIG. 3 is a flowchart, showing a more detailed example of an embodiment of a method for computing a life data distribution, as represented by the block 8 of FIG. 1.

The input to the method is the data from the equipment population, obtained by the method represented as the block 6. In one embodiment, this equipment population data includes, for each piece of equipment in the population, the shipment records and failure records described above.

First, as shown in a block 12, ages are calculated for pieces of equipment in the equipment population, relative to respective time reference points such as their shipment dates and the Calculation Date. In one embodiment, the ages are calculated from such shipment dates up until the Calculation Date (as defined above). The calculations take into consideration whether an incidence of failure has been reported for the piece of equipment. In one embodiment, the ages of pieces of equipment that have survived, i.e., have not yet failed as of the Calculation Date, are also calculated.

Then, as shown in a block 14, the above-calculated age information for failed products, and for unfailed products, are input into a parametric reliability data analysis tool. An example of such a tool is the Weibull++ product of ReliaSoft Corporation. Such a tool or technique calculates parameters for the data, such that a life data distribution model (herein also called “life data distribution” or “distribution”) employing the parameters will fit the observed data. Tools such as the ReliaSoft tool mentioned above may be employed, so as to seek a best fit between the model and the observed data.

Next, as shown in a block 16, a life data distribution that fits the data is selected. Known statistical tests, such as Goodness Of Fit test and the Likelihood Function, are used for determining which model best fits the data.

It will sometimes be the case that the parametric reliability data analysis tool will indicate that a single life data distribution clearly best fits the data, and this life data distribution is the one that is selected. In other instances, it will indicate multiple distributions that fit the data. In such latter instances, one of the distributions is then selected. In one embodiment, selecting the distribution that yields the lowest fail rate is selected, because experimentation has shown that such a distribution generally provides the best predictive result.

Then, as shown in a block 18, a calculation is done, to predict an expected failure rate. The result of this calculation is the FFR for that Reporting Month. For instance, in one embodiment the FFR can include a calculation of the percent of failed products expected after one year of operation.

After the failure rate computation of the block 8 of FIG. 1 is completed (such as by the method of FIG. 2), the FFR may be kept, for comparison with FFRs calculated for other Calculation Dates. For instance, there may be a Calculation Date some time after the end of each time interval (such as after the end of each month, i.e., the end of each FFR Reporting Month).

For a successive failure rate computation on a successive Calculation Date, new failure data will have come in, and certain pieces of equipment, within the equipment population, that had heretofore not failed, will now have failed. Also, newly sold or shipped pieces of equipment will be added to the equipment population. Therefore, an FFR calculation on this subsequent Calculation Date will likely produce a different result due to such new data.

Therefore, the method of FIG. 1 also includes processing the newly calculated FFR, along with previously calculated FFRs. In one embodiment, as shown in an activity represented in FIG. 1 by a block 10, such processing includes plotting the calculated FFRs as a function of the respective time intervals. For instance, where failure data is reported monthly and FFR calculations are done following each such monthly report, the block 10 represents the activity of plotting the FFR, by Reporting Month, over time (such as from the equipment introduction up through the most recent failure report).

The plot, or other processing, produced by the block 10, is then used to predict changes in the associated AFR. For instance, the plot may show a trend line, and subsequent development of the trend can then be extrapolated.

Through analysis of shipment and failure data associated with more than a dozen different products involving complex microwave/RF measurement equipment, the FFR Method has been effective in predicting future AFR trends by using a shipment evaluation window in the range of four to six months.

Although the present invention has been described in detail with reference to particular embodiments, persons possessing ordinary skill in the art to which this invention pertains will appreciate that various modifications and enhancements may be made without departing from the spirit and scope of the claims that follow.

What is claimed is:

1. A fail rate method, for determining a failure rate for a population of pieces of equipment in use over a period of time, the method comprising:
selecting a period of time;
segmenting the period of time into multiple time intervals;
obtaining data for the population of pieces of equipment, the data broken down over the time intervals;
computing a life data distribution for the data, the life data distribution being associated with a given time, and being based on the obtained data for time intervals prior to the given point in time.

2. A method as recited in claim 1, wherein obtaining data includes obtaining shipment data and failure data.

3. A method as recited in claim 1, wherein the segmenting includes segmenting the period of time into one-month time intervals.

4. A method as recited in claim 3, wherein the period of time is four to six months.

5. A method as recited in claim 1, wherein the obtaining data includes (i) obtaining respective records for respective ones of the pieces of equipment, and (ii) identifying failure records of the respective records.

6. A method as recited in claim 5, wherein the respective records include shipment records.

7. A method as recited in claim 1: further comprising:
at a time subsequent to the given time, obtaining updated data for the population of pieces of equipment, the data broken down over the time intervals; and
computing a life data distribution for the data, the life data distribution being associated with the subsequent time, and being based on the obtained data for time intervals prior to the given point in time.

8. A method as recited in claim 7, further comprising making a prediction about the failure rate for the population of pieces of equipment, based on the computed life data distribution.

9. A method as recited in claim 1, further comprising:
at a time subsequent to the given time, obtaining data for the population of pieces of equipment, for a time interval subsequent to the period of time, and
computing a life data distribution for the data, the life data distribution being associated with a time subsequent to the given time, and being based (i) on the obtained data for time intervals prior to the given point in time, and (ii) on the obtained data for the time interval subsequent to the given point in time.

10. A method as recited in claim 9, further comprising making a prediction about the failure rate for the population of pieces of equipment, based on the computed life data distribution.

11. A computer program product for determining an instantaneous fail rate for a population of pieces of equipment in use over a period of time, the computer program product comprising:
a computer readable medium; and
software provided on the medium for directing a computer to perform a method of:
selecting a period of time;
segmenting the period of time into multiple time intervals;
obtaining data, including failure data, for the population of pieces of equipment, the data broken down over the time intervals;
computing a life data distribution for the data, the life data distribution being associated with a given time, and being based on the obtained data for time intervals prior to the given point in time.

12. A computer program product as recited in claim 11, wherein the obtaining data includes obtaining shipment data and failure data.

13. A computer program product as recited in claim 11, wherein the segmenting includes segmenting the period of time into one-month time intervals.

14. A computer program product as recited in claim 13, wherein the period of time is four to six months.

15. A computer program product as recited in claim 11, wherein the obtaining data includes (i) obtaining respective records for respective ones of the pieces of equipment, and (ii) identifying failure records of the respective records.

16. A computer program product as recited in claim 15, wherein the respective records include shipment records.

17. A computer program product as recited in claim 11: wherein the software directs a computer to perform a method further comprising:
at a time subsequent to the given time, obtaining updated data for the population of pieces of equipment, the data broken down over the time intervals; and
computing a life data distribution for the data, the life data distribution being associated with the subsequent time, and being based on the obtained data for time intervals prior to the given point in time.

18. A computer program product as recited in claim 17, wherein the software directs a computer to perform a method further comprising making a prediction about the failure rate for the population of pieces of equipment, based on the computed life data distribution.

19. A computer program product as recited in claim 11, wherein the software directs a computer to perform a method further comprising:
at a time subsequent to the given time, obtaining data for the population of pieces of equipment, for a time interval subsequent to the period of time, and
computing a life data distribution for the data, the life data distribution being associated with a time subsequent to the given time, and being based (i) on the obtained data for time intervals prior to the given point in time, and (ii) on the obtained data for the time interval subsequent to the given point in time.

20. A computer program product as recited in claim 19, wherein the software directs a computer to perform a method further comprising making a prediction about the failure rate for the population of pieces of equipment, based on the computed life data distribution.
